(19) United States
(12) Patent Application Publication
(10) Pub. No.: US 2014/0250623 A1
(43) Pub. Date: Sep. 11, 2014

(54) BladeBoot®is a wind shield wiper and arm protector, made of insulated foam rubber tubing. This tube is an easy slide on and off application that slips over exiting wiper blades and arms of parked vehicles. Used for hot and cold weather protection against ice, snow and dry rot.

(71) Applicants: Kevin Mark Hochertz, Richmond, IL (US); Cheryl Ann Wasik, Richmond, IL (US)

(72) Inventors: Kevin Mark Hochertz, Richmond, IL (US); Cheryl Ann Wasik, Richmond, IL (US)

(21) Appl. No.: 13/739,009

(22) Filed: Mar. 8, 2013

(51) Int. Cl. B60S 1/04

(52) U.S. Cl. CPC B60S 1/0491
USPC 15/257.01

(57) ABSTRACT

A device made of insulated foam rubber, with added vinyl pieces, that fits over windshield wipers and wiper arms of vehicles, equipment and boats, that protects wiper blades and arms from harsh elements. Using this boot acts as a barrier between harsh weather elements protecting against excessive heat, snow and ice from damaging wipers and arms. By sliding these single piece devices over each wiper blade and arm it provides 100% UV protection while shielding against harsh elements. Wiper blades and arms are protected against damage from sticking to the windshield while vehicle is in a parked position. Additional vinyl strips and/or vinyl lettering assist in easier removal of the device in wintery and excessive heat conditions.

### BACKGROUND OF THE INVENTION

1. Field of the Invention

This invention relates generally to windshield wiper blades, arms, and lower windshield protection to be used when the vehicle is parked. It is a tool to be used as a preventative measure for protecting windshield wiper assemblies. It is an all season boot made for protecting windshield wiper blades from dry rot and protects wipers and wiper arms from harsh environmental conditions. Wipers and arms will not accumulate snow and ice using this invention.

2. Description of Related Art

A critical problem encountered by everyday drivers of how to prevent snow and ice from accumulating on windshield wiper blades and their arm assemblies while their vehicle is in the parked state. One challenge is that wiper blades come in many lengths as do their wiper arm assemblies. Different automobiles typically have windshields of different sizes and shapes, and providing an insulated barrier is a defense against trying to remove snow and be off of a wiper blade can be a difficult task. This design prevents the arm assembly springs from being damaged by replacing the alternate method of pulling the blade straight out from the cars' windshields, which proves to be damaging to both the wiper blades and the spring tension in the arm assemblies. For warm climates, the melting of wiper blades to the windshield in high temperatures can also prove damaging.

A bare windshield wiper and arm assembly while left out in the harsh elements is a victim to winter weather when snow, sleet, or ice accumulate on the wiper blade and freezing the blade to the windshield. Any movement of this wiper blade assembly while bare wipers are frozen in place poses a high possibility of damage to the blade being torn off, or wiper arm motors failing prematurely due to motor burn out. The foam rubber boot hinders any contact between the wiper blade and wiper arm which prevents the assembly from freezing to the windshield. Since the wiper blade is not exposed during harsh weather while parked it does not have any contact with the windshield, it provides a fresh start to winter drivers.

Nylon fabric applications and other products to do not provide 100% UV protection. Velcro applications of this material accumulate snow and ice and are not easily applied arid removed in between uses.

A need exists, therefore, for a winter boot made from foam rubber, with a clear strip of vinyl applied to the bottom, makes this boot a better choice for easy on and easy off application. It does not contain Velcro and does not roll up and flop over making application difficult in other applications. Its resistance and superior resistance to ultra-violet radiation, ozone, and extreme temperatures, especially low temperatures makes this boot a great choice for parked vehicles. Temperature range is ° C. −40 . . . +105 and has an aging resistance consists of approximately 150 hours, with slight wrinkles, no cracks, holes or distortion. A need also exists for a wipers and arm assembly of stored vehicles to be protected against dry rot and melting of wiper blades.

### BRIEF SUMMARY OF THE INVENTION

The problem with wiper blade and arm assembly accumulating ice and snow, and extreme heat damage of parked vehicles are solved by the present invention. A protective wiper boot is provided that includes a tubular open ended foam rubber sleeve cover. Preferably, the storage boot slides over wiper and arm assemblies on parked vehicles. This invention is not used while vehicle is in drive mode.

The embodiment, a foam rubber cover includes an insulated tubular product that is open ended on both sides with a clear vinyl strip on the bottom providing extra strength and a smoother surface for application. Wipers and arms are encased in this insulated environment.

Other objects, features, and advantages of the present invention will become apparent with reference to the drawings and detailed description that follow.

### BRIEF DESCRIPTION OF THE DRAWINGS

FIG. 1 illustrates a top view of the protective wiper boot made of insulated foam rubber this view can also be used for advertising phrases that are made of vinyl and affixed.

FIG. 2 illustrates a bottom view of the protective wiper boot made of insulated foam rubber with vinyl bottom strip of FIG. 1;

FIG. 3 illustrates a side view of the protective wiper boot of FIG. 2; and

FIG. 4 illustrates cross-sectional view of the wiper blade boot of FIG. 2.

### DETAILED DESCRIPTION OF THE PREFERRED EMBODIMENT

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

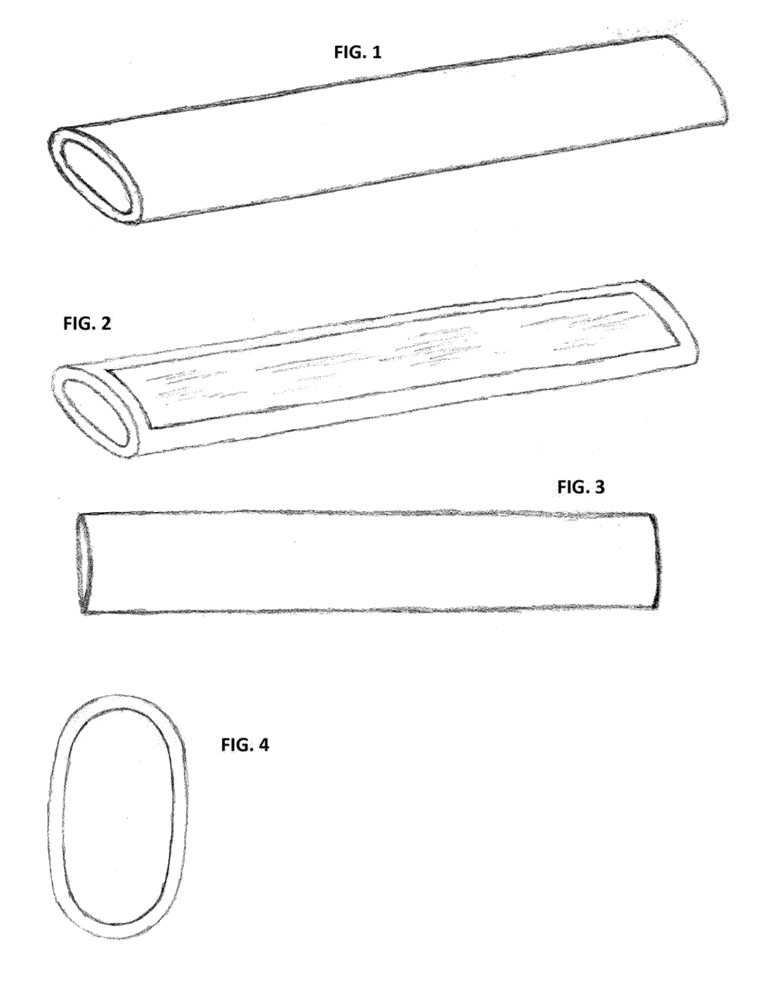

Referring to FIG. 1 in the drawings, the wiper blade and arm boot has a 2.0″ inner diameter and ¼″ thickness and has an average length of 32″ inches. Thickness and length may vary.

When installed on an automobile, airplane or other vehicle having a windshield, it is when it is in the parked state only, and not when in motion.

Referring to FIG. 2 in the drawings, illustrates the bottom of the foam insulated rubber continuous tubing with a vinyl strip on the bottom to help strengthen the boot and aid in the ease of applying and removal.

A person having ordinary skill in the art will recognize that the thickness of the “walls in FIG. 1 and FIG. 4 are for illustrative purposes and the actual thickness of the walls could be thicker.

Referring to FIG. 3 in the drawings the tubing is continuo s and open on both sides with no slit length wise.

The wipe blade and arm boot is preferably installed by simply sliding the tube over until all of the wiper blade has been covered and the arm as well.

A foam rubber insulated boot provides many advantages, some of which include superior resistance to ultra-violet radiation, ozone, and extreme temperatures. Previous wiper boots have been made from cloth like material or nylon, which absorb moisture. One of the main problems with cloth like and nylon materials, is they hold moisture which could have the material adhere to the windshield while the car is in a parked state. When temperatures drop to freezing and below, cloth and nylon become frozen to the snow and ice hindering a safe separation from the application and the windshield.

From the foregoing, it will be recognized that the wiper boot of the present invention provides a superior system for protecting a wiper blade and arm assembly from harsh weather conditions including snow, sleet, and ice and extreme heat. The installation of the wiper boot on the wiper assembly prevents the snow, sleet, and ice from penetrating the pivotal joints of the wiper arm, which allows the frame to function properly by providing a barrier against the harsh elements so a fresh start is accomplished. There is no contact between the wiper blade and the windshield while this wiper boot is in place. It should be apparent from the foregoing that an invention having significant advantages has been provided. While the invention is shown in only a few of its forms, it is not just limited but is susceptible to various changes and modifications without departing from the spirit thereof.

1. (canceled)

2. (canceled)

3. (canceled)

4. A tubular insulated foam rubber device cover that encompasses the wiper blade, the wiper blade assembly and the wiper arm within a single containment. This insulated foam rubber tubular device is completely hollow inside from end to end which enables the ease of sliding over the wiper blade, wiper assembly and wiper arm in a single application. The tubular foam rubber device is made for use on vehicles, boats and equipment.

5. The vinyl strip located on the bottom of this tubular insulated foam rubber device as described in claim 1, allows for greater strength of the device, and aids to the ease of sliding on or off while the device is exposed to harsh weather elements or when the device is resting in place against the windshield for extended periods of time, therefore preventing wiper blade material loss or dry rot. Additional top vinyl applications add to the strength and durability of the tubular insulated foam rubber device.

6. This tubular insulated foam rubber device as described in claim 1, protects the wiper blades, wiper assembly and wiper arms from damage of outside elements such as mud, debris, hail, freezing rain, snow, and extreme heat including UV ray exposure.
